(19) United States
(12) Patent Application Publication
(10) Pub. No.: US 2002/0186008 A1
(43) Pub. Date: Dec. 12, 2002

(54) Non-metallic encoder for an in-bearing active wheel speed sensing system

(76) Inventor: Jason D. Turner, Dearborn Heights, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 09/879,388

(22) Filed: Jun. 12, 2001

(51) Int. Cl. G01P 3/48

(52) U.S. Cl. 324/207.22; 324/174

(57) ABSTRACT

An encoder for an active speed sensor includes a non-metallic body embedded with magnetized ferrous particles generating a magnetic field. The encoder is mounted radially between inner and outer races of a wheel bearing and axially between a spaced pair of rollers of the bearing. The body is attached to a press ring that is retained on the inner race by a press fit. A non back-biased sensor extends through the outer ring proximate the body.

### BACKGROUND OF THE INVENTION

The present invention relates generally to rotating equipment speed sensing devices and, in particular, to a non-metallic encoder for use in a non back-biased in-bearing active vehicle wheel speed sensor system.

Vehicle wheel speed sensor systems are well known. Rotational speed is used for numerous measurement devices and control systems, including vehicle speedometer readings, vehicle cruise control feedback, and vehicle antilock braking system feedback. Speed sensor systems typically operate by means of a target installed on the rotating equipment. This target is paired with a stationary sensor and is separated from the stationary sensor by an air gap. The stationary sensor generates a signal when the moving target passes over it. The number of times the target passes over the sensor, or the frequency of signals generated, in a given period of time, is then converted to a rotating speed and passed on to the appropriate measurement device or control system.

Vehicle wheel speed sensing systems are typically grouped into two types, active sensor systems and passive sensor systems. Passive sensors do not require a power supply in order to operate. In a passive sensor system, the stationary sensor is a permanent magnet that projects a magnetic field into the air gap. The stationary sensor detects a change in the magnetic field's reluctance caused by the moving target, typically a toothed wheel made of ferrous material, as it passes through the magnetic field. The output of the passive sensor is a raw analog signal that varies greatly with the rotational speed of the vehicle wheel. The output of the passive sensor is also susceptible to false signals when the wheel is subjected to vibration. In addition, passive sensors are limited to a close clearance air gap of about 1 to 2 mm.

Active sensor systems represent the next generation technology to be utilized in vehicle wheel speed sensing devices. Active sensor systems typically utilize one of two technology devices, which are well known in the art as Hall Effect devices or Magneto-Resistive devices. The two technologies have been found to be comparable in terms of performance. Active sensor systems require a power supply to operate and are further divided into two categories, back-biased sensors and non back-biased sensors. Back-biased sensors generate the magnetic field from the stationary sensor, while the moving target, or encoder, is constructed of ferrous material, as in the passive sensor system. Non-back biased sensors, conversely, generate the magnetic field from the encoder. Because the magnetic field is generated from the moving target, non back-biased stationary sensors do not need magnets, require correspondingly fewer components and are thus smaller than back-biased stationary sensors. Sensors installed in either back-biased or non back-biased form detect the frequency of the changes in voltage of the magnetic field, and direct the output to the appropriate measurement device or control system. The output of the active sensor, in either back-biased or non back-biased form, is a high quality digital signal that varies between fixed values and is not affected by the rotational speed of the wheel. Active sensor control systems are smaller than passive sensor control systems, can function at zero rotational speed, are immune to false signals due to vibration, and are capable of having a greater air gap than passive stationary sensors. Further, the next generation of active sensor systems will be able to detect when the vehicle wheel rotates in reverse, a necessary element in some control systems, such as vehicle navigation systems. The next generation of active sensor systems will also have diagnostic capability. Active vehicle wheel speed sensor systems, therefore, will play a large role in the improvement of current vehicle control systems as well as in the development of future vehicle control systems and will likely be the preferred means of sensing vehicle wheel speed.

Because of their smaller sensor size, non back-biased active speed sensor systems are preferred in vehicle wheel applications. Non-back biased vehicle wheel speed sensor systems are generally installed in the wheel bearing. Because the vehicle wheel bearing is usually made of a ferrous material, the encoder in a non back-biased active system typically is made of a non-magnetic material that is embedded with ferrous particles or fibers, which are then magnetized. The non-magnetic material shields the magnetic field from the rest of the vehicle wheel, but allows the magnetized fibers to project a magnetic field into the air gap. Prior art non back-biased active sensors utilized encoders that were installed external to the bearing, for example in the bearing seal between the inner and outer race of the bearing. The bearing seal was attached to the inner or outer race, which spun with the vehicle wheel and provided the desired rotational speed. These prior art non back-biased sensors were smaller than both passive sensors and back-biased active sensors, but were still fairly large in size. This was primarily due to the location of the stationary sensor, which was located on the outwardly axial end of the bearing. This increased the bearing's axial width to one greater than the original axial width of the inner and outer races. In addition, the prior art encoders for non back-biased sensors were of rubber construction only. Prior art back-biased sensors have been used in an in-bearing configuration. These in-bearing configurations, however, utilized a ferrous target with large back-biased sensors. The size of the back-biased sensors limited the use of the bearing.

It is a continuing goal in speed sensor system design to reduce the size of the various components, which leads to greater packaging flexibility and generic design opportunities. It is desirable to produce a true in-bearing active sensor system that is reduced in size compared to passive and back-biased active sensor systems. It is also desirable to produce a non-metallic moving encoder for active sensors that is integrated with the rotating member, such as a wheel bearing housing, and to utilize standard size bearings with non back-biased stationary sensors. It is further desirable to construct the encoder of a plastic material in addition to a rubber material.

### SUMMARY OF THE INVENTION

The present invention concerns a novel moving target for an active non back-biased in-bearing vehicle wheel speed sensing system. Prior art moving targets, or encoders, for active non back-biased speed sensing systems, as noted above, were all installed external to the vehicle wheel bearing. The present invention attaches the encoder directly within a commonly manufactured type known in the art as a “Generation 2” or “Generation 3” vehicle wheel bearing. Attaching the encoder within the vehicle wheel bearing allows the sensor as well as the overall speed sensor system to be made smaller as compared to passive speed sensors, back-biased sensors, and prior art non back-biased speed sensors, leading to greater packaging flexibility and generic design opportunities.

The present invention discloses a non-metallic encoder attached directly to the inner race of a standard sized wheel roller bearing, known in the art as a Generation 2 or Generation 3 bearing. The encoder is preferably constructed of plastic material that is embedded with ferrous particles or fibers, which are then magnetized. The encoder may also be constructed of rubber or any other non-metallic material. The encoder is typically in the shape of an annular ring that completely encircles the circumference of the inner race. Because the embedded ferrous materials generate the magnetic field, there is no need for the encoder to have a specific physical profile. The encoder is press-fit directly into the inner race. The encoder is further affixed to the inner race by an adhesive or by the use of crush rods or similar geometry. Alternatively, the encoder can be constructed with an insert molded press ring that is used for ease of installation into the inner race. The purpose of the press ring is to retain the encoder in the inner race via a press fit and to absorb the compression forces that the encoder is subjected to during assembly so that the encoder's plastic material does not crack. In addition, the press ring is typically constructed of a ferrous material, which makes the encoder more robust during the life of the part. The press ring can be of a solid construction or constructed with a profile that lends itself to absorb compression forces and account for the difference in coefficient of thermal expansion between the different encoder materials.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross-sectional view of one vehicle wheel speed sensor in accordance with the present invention;

FIG. 2 is a cross-sectional profile view of a vehicle wheel speed sensor encoder in accordance with the present invention; and

FIGS. 3a-3d are cross-sectional profile views of alternative embodiments of vehicle wheel speed sensor encoders in accordance with the present invention

### DESCRIPTION OF THE PREFERRED EMBODIMENT

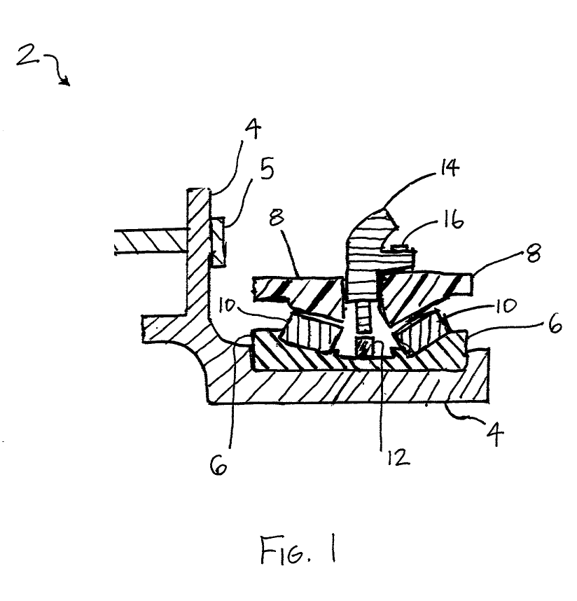

Referring to FIGS. 1 and 2, a vehicle wheel speed sensor is shown generally at 2, which detects the rotational speed of a rotating member, such as an automobile axle. The speed sensor 2 utilizes a bearing that is of a commonly manufactured type known in the art as a “Generation 2” or “Generation 3” bearing. The bearing contains a hub section 4 that connects via a fastener 5 to a rotating member (not shown) such as an automobile wheel shaft. The bearing, further consisting of an annular inner race 6 concentric with an annular outer race 8, and a plurality of rollers 10 positioned in two axially spaced rows between the races. The inner race 6 is attached to the hub section 4 so that the inner race 6 and the hub section 4 spin with the rotating member. The rollers 10 may be balls, rollers, or tapered rollers, depending on design and operational requirements. Positioned axially between the rows of rollers 10 and radially between the inner race 6 and outer race 8 is an encoder 12. The encoder 12 is further affixed to the inner race 6 by an adhesive (not shown) or by an interference fit using crush rods or similar geometry (not shown) in a manner well known in the art. A body of the encoder 12 is formed of non-metallic material that is embedded with a plurality of ferrous particles 13.

The ferrous particles 13 can compose around 65% of the volume of material forming the encoder 12. The actual percentage of ferrous particles 13, however, is not critical, but the body of the encoder 12 must contain enough ferrous particles 13 in order for the particles 13 to be magnetized and to be able to generate a magnetic field. The ferrous particles 13 are magnetized prior to the encoder 12 being inserted in between inner race 6 and outer race 8. Referring again to FIG. 1, the encoder 12 spins with the inner race 6 and the rotating member 4. The magnetized ferrous particles 13 within the encoder 12 emit a magnetic field (not shown) in an outwardly radial direction from the hub 4. This magnetic field impinges upon a stationary non back-biased active sensor 14. The sensor 14 is received in a bored passage in the outer race 8, projects in an inwardly radial toward the hub 4, and approaches, but does not touch the encoder 12. The radial distance between the encoder 12 and the sensor 14 is called the air gap. The sensor 14 is connected to the outer race by a fastening means 16. The fastening means 16 may be a threaded fastener, a rivet, a type of weld, or any other fastening means well known in the art. The sensor 14 is a non back-biased type sensor, which is much smaller in size than the prior art back-biased type sensors. The sensor 14, utilizing either a Hall Effect device or Magneto-Resistive device (not shown), each of which is well known in the art, detects the frequency of the changes in voltage of the magnetic field. The sensor 14 is further electrically connected to a power supply (not shown) that supplies energy to a circuit (not shown) that directs the digital output of the sensor 14 to an electronic control unit (not shown) or a measurement device (not shown.).

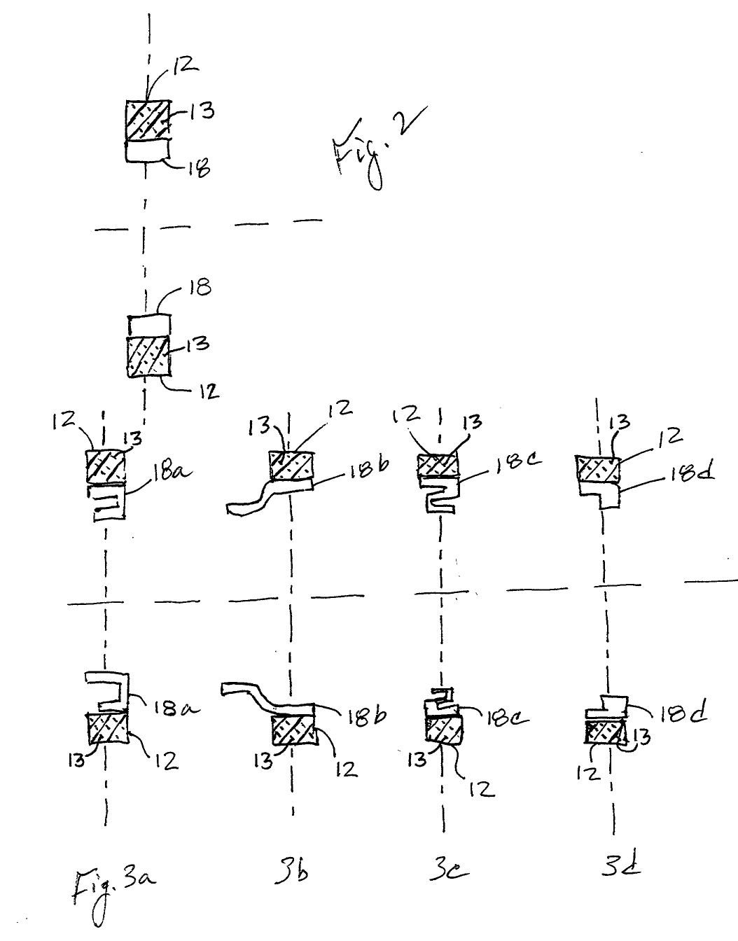

The encoder 12 can be manufactured as a solid piece of non-metallic material that is later pressed into place. Alternatively, the body of the encoder 12 can be manufactured with an integral insert molded press ring 18, as shown in FIG. 2. The press ring 18, typically constructed of a ferrous material, can be manufactured in a number of configurations and profiles, such as a solid piece, or various shaped configurations, as shown in FIGS. 3a-3d. The press ring 18 is used for ease of installation of the encoder 12 into the inner race 6. The press ring 18 retains the encoder 12 in the inner race 6 via a press fit and absorbs the compression forces that the encoder 12 is subjected to during assembly so that the plastic material does not crack. In addition, the ferrous material of the press ring 18 makes the encoder 12 more robust during the design life of the encoder 12. The press ring 18 can be of a solid construction or constructed with a profile that lends itself to absorb compression forces and account for the difference in coefficient of thermal expansion between the different encoder materials. The profile of the press ring 18 is not critical, as long as the profile lends itself to absorb compression forces and account for the difference in coefficient of thermal expansion between the different encoder materials, and as long as the non-metallic material of the encoder 12 sufficiently insulates the ferrous particles 13 from the press ring 18 and the inner race 6. This is best seen in FIGS. 3a-3d, where alternate variations of the profile of the press ring 18a, 18b, 18c, and 18d are shown in accordance with the present invention. Press ring 18a has a generally ‘C’-shaped profile, press ring 18b has a generally flattened and elongated ‘Z’-shaped profile, press ring 18c has a generally ‘S’-shaped profile, and press ring 18d has a generally ‘L’-shaped profile.

The true in-bearing configuration of the vehicle wheel speed sensor system 2 allows the sensor system 2 to be of a much smaller size, which leads to greater packaging flexibility and generic design opportunities.

In accordance with the provisions of the patent statutes, the present invention has been described in what is considered to represent its preferred embodiment. However, it should be noted that the invention can be practiced otherwise than as specifically illustrated and described without departing from its spirit or scope. For example, the present invention could be utilized in numerous types of rotating equipment and, therefore, is not limited solely to applications in motor vehicles.

What is claimed is:

1. An encoder for an in-bearing active wheel speed sensing system, the bearing having concentric annular inner and outer races with two axially spaced apart rows of rollers therebetween, comprising:
an encoder body formed of a non-metallic material, said encoder body adapted to be affixed to an inner race of a wheel bearing and positioned radially between the inner race and an outer race of the bearing and positioned axially between two rows of axially spaced rollers of the bearing; and
a plurality of magnetized ferrous particles integrated within said non-metallic body for generating a magnetic field.

2. The encoder according to claim 1 including a non back-biased sensor adapted to be mounted on the outer race and extending into proximity to said encoder body.

3. The encoder according to claim 1 wherein said non-metallic material is plastic.

4. The encoder according to claim 1 wherein said non-metallic material is rubber.

5. The encoder according to claim 1 wherein said encoder body is attached to a press ring adapted to retain said encoder body on the inner race by a press fit.

6. The encoder according to claim 5 wherein said press ring has a generally C-shaped profile.

7. The encoder according to claim 5 wherein said press ring has a generally Z-shaped profile.

8. The encoder according to claim 5 wherein said press ring has a generally S-shaped profile.

9. The encoder according to claim 5 wherein said press ring has a generally L-shaped profile.

10. The encoder according to claim 5 wherein said press ring is formed of a ferrous material.

11. An in-bearing active wheel speed sensing system comprising:
a wheel bearing having concentric annular inner and outer races with two axially spaced apart rows of rollers therebetween;
an encoder body formed of a non-metallic material, said encoder body being mounted to said inner race and positioned radially between said inner and outer races and positioned axially between said rows of rollers;
a plurality of magnetized ferrous particles integrated within said non-metallic body for generating a magnetic field; and
an active sensor mounted to said outer race and positioned for sensing said magnetic field.

12. The system according to claim 11 wherein said active sensor extends through said outer race into proximity with said encoder body.

13. The system according to claim 11 wherein said active sensor is a non back-biased sensor.

14. The system according to claim 11 wherein said non-metallic material is plastic.

15. The system according to claim 11 wherein said non-metallic material is rubber.

16. The encoder according to claim 11 wherein said encoder body is attached to a press ring retained on said inner race by a press fit.
